(19) United States
(12) Patent Application Publication
(10) Pub. No.: US 2013/0056266 A1
(43) Pub. Date: Mar. 7, 2013

(54) ANTICORROSIVE, COATED ELECTRIC WIRE WITH TERMINAL, AND WIRING HARNESS

(71) Applicants: Masato Inoue, Yokkaichi-shi (JP); Hiroshi Sudou, Yokkaichi-shi (JP); Yukiyasu Sakamoto, Yokkaichi-shi (JP); Hiroshi Yamaguchi, Yokkaichi-shi (JP); Hisahiro Yasuda, Yokkaichi-shi (JP); Tetsuya Nakamura, Yokkaichi-shi (JP); Shigeyuki Tanaka, Yokkaichi-shi (JP); Kazuo Nakashima, Yokkaichi-shi (JP)

(72) Inventors: Masato Inoue, Yokkaichi-shi (JP); Hiroshi Sudou, Yokkaichi-shi (JP); Yukiyasu Sakamoto, Yokkaichi-shi (JP); Hiroshi Yamaguchi, Yokkaichi-shi (JP); Hisahiro Yasuda, Yokkaichi-shi (JP); Tetsuya Nakamura, Yokkaichi-shi (JP); Shigeyuki Tanaka, Yokkaichi-shi (JP); Kazuo Nakashima, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/698,457

(22) PCT Filed: Jun. 9, 2011
(86) PCT No.: PCT/JP2011/063244

§ 371 Date: Nov. 16, 2012

(30) Foreign Application Priority Data
Jun. 14, 2010 (JP) 2010-134706

(51) Int. Cl. C08F 114/06; C08F 120/02; C08G 69/00; C08G 59/02; H02G 15/02; C08F 220/12

(52) U.S. Cl. 174/72 A; 174/74 R; 524/567; 524/563; 524/606; 523/400; 524/556

(57) ABSTRACT

Provided is an anticorrosive that is capable of demonstrating high anticorrosive capability both at an early stage and at a later stage after exposure to ultraviolet light. The anticorrosive mainly contains an insulating resin, and has a total light transmittance of less than 85%, which is measured in accordance with the JIS K7361-1. The anticorrosive can be favorably applied to an electrically connected portion between a wire conductor of a coated electric wire with a terminal and a terminal member. The coated electric wire with the terminal includes the wire conductor and the terminal member, wherein the electrically connected portion between the wire conductor and the terminal member is coated with the anticorrosive.

### TECHNICAL FIELD

The present invention relates to an anticorrosive, a coated electric wire with a terminal, and a wiring harness, and more specifically relates to an anticorrosive that is favorably used to prevent corrosion from building up at an electrically connected portion between a wire conductor and a terminal member, a coated electric wire with a terminal using the anticorrosive, and a wiring harness using the anticorrosive.

### BACKGROUND ART

Conventionally, a coated electric wire, which is prepared by coating a wire conductor made of an annealed wire such as tough pitch copper with an insulation, is in widespread use as an electric wire used for wiring in a car such as an automobile. A terminal member is connected to the wire conductor at an end of the coated electric wire, where the wire conductor is exposed by stripping off the insulation. The terminal member that is electrically connected to the end of the coated electric wire is inserted and locked into a connector.

A plurality of the coated electric wires with the terminals are bunched into a wiring harness. The coated electric wires in the form of wiring harness are used for wiring in a car such as an automobile.

Used for wiring in an engine room or a certain indoor environment that is subject to water, the wiring harness is susceptible to heat and water, which results in formation of rust at electrically connected portions between the wire conductors and the terminal members. For this reason, it is necessary to prevent corrosion from building up at the electrically connected portions when the wiring harness is used in this environment.

In order to prevent corrosion from building up at the electrically connected portions, PTL 1 discloses a technique to fill with grease the connectors into which the terminal members connected to the wire conductors are inserted and locked.

### CITATION LIST

### Patent Literature

PTL1: JP05-159846A

### SUMMARY OF INVENTION

### Technical Problem

These days, there are increasing tendencies to improve fuel efficiency by weight reduction of a car such as an automobile, and accordingly weight reduction of material for the electric wires that make up the wiring harness is demanded. For this reason, using aluminum for the wire conductors is considered.

Copper or a copper alloy that has excellent electric properties is generally used for the terminal members, and accordingly the aluminum electric wires and the copper terminal members are of ten used in combination. However, when the wire conductors are different in material from the terminal members, bimetallic corrosion builds up at the electrically connected portions. This kind of corrosion builds up more easily compared with the case of using a same material for the wire conductors and the terminal members. For this reason, an anticorrosive is required, which can prevent corrosion from building up at the electrically connected portions in a convincing way.

However, the conventional grease is not capable of sufficiently preventing water immersion if it is not filled densely in the connectors. If the amount of grease filling is increased in order to enhance the anticorrosion effect, the grease is unintentionally coated on a portion where corrosion prevention is not needed. In addition, excessive filling makes the connectors and the electric wires sticky, which decreases handleability. For this reason, an anticorrosive that is capable of demonstrating high anticorrosive capability is required as a replacement for the problematic grease.

In addition, after applied to the electrically connected portion, the anticorrosive could be sometimes exposed to ultraviolet light for quality inspection or exposed to artificial light such as fluorescent light and incandescent light or sunlight when used. The anticorrosive is required to demonstrate high anticorrosive capability even after the exposure in view of reliability. Light that is especially important among assumed various kinds of exposure light is ultraviolet light.

The present invention has been made in view of the above circumstances and has an object to overcome the above problems, and to provide an anticorrosive that is capable of demonstrating high anticorrosive capability both at an early stage and at a later stage after exposure to ultraviolet light. Other objects of the present invention are to provide a coated electric wire with a terminal using the anticorrosive, and to provide a wiring harness using the anticorrosive.

### Solution to Problem

In order to solve the problems described above, the anticorrosive of the present invention mainly contains an insulating resin, and has a total light transmittance of less than 85%, which is measured in accordance with the JIS K7361-1.

It is preferable that the anticorrosive defines an anticorrosive that is applied to an electrically connected portion between a wire conductor and a terminal member.

In another aspect of the present invention, a coated electric wire with a terminal includes a wire conductor and a terminal member, wherein an electrically connected portion between the wire conductor and the terminal member is coated with the anticorrosive.

It is preferable that in the coated electric wire with the terminal, the wire conductor includes elemental wires made of aluminum or an aluminum alloy, and the terminal member is made of copper or a copper alloy.

Yet, in another aspect of the present invention, a wiring harness includes the coated electric wire with the terminal.

### Advantageous Effects of Invention

Mainly containing the insulating resin, and having the total light transmittance of less than 85%, which is measured in accordance with the JIS K7361-1, the anticorrosive of the present invention has an excellent coating property compared with grease, and is capable of demonstrating high anticorrosive capability. Further, the anticorrosive of the present invention is capable of demonstrating high anticorrosive capability even if exposed to ultraviolet light.

Applied to the electrically connected portion between the wire conductor and the terminal member, the anticorrosive of the present invention can improve corrosion resistance capability of the electrically connected portion, which allows the electrically connected portion to have increased connecting reliability. In addition, even if exposed to ultraviolet light for quality inspection or when used, the anticorrosive of the present invention is capable of demonstrating high anticorrosive capability.

Having the configuration that the electrically connected portion between the wire conductor and the terminal member is coated with the anticorrosive, the coated electric wire of the present invention has the electrically connected portion that has improved corrosion resistance capability, which allows the coated electric wire to have increased connecting reliability. In addition, even if exposed to ultraviolet light for quality inspection or when used, the coated electric wire of the present invention is capable of demonstrating high anticorrosive capability, and is thus superior in durability.

If the wire conductor includes the elemental wires made of aluminum or an aluminum alloy and the terminal member is made of copper or a copper alloy, which establishes bimetallic connection, full use of the effect of the anticorrosive of the present invention can be made.

The wiring harness of the present invention includes the coated electric wire that has improved anticorrosive capability. Thus, the wiring harness can be used favorably for wiring in an engine room or a certain indoor environment that is subject to water.

### BRIEF DESCRIPTION OF DRAWINGS

FIG. 1 is a view showing a coated electric wire with a terminal of a first preferred embodiment of the present invention.

FIG. 2 is a cross-sectional view showing the same along the line A-A of FIG. 1.

FIG. 3 is a view for illustrating a corrosion test.

### DESCRIPTION OF EMBODIMENTS

Detailed descriptions of an anticorrosive of preferred embodiments of the present invention (hereinafter, referred to also as the “present anticorrosive”), a coated electric wire with a terminal of preferred embodiments of the present invention (hereinafter, referred to also as the “present coated electric wire”), and a wiring harness of preferred embodiments of the present invention (hereinafter, referred to also as the “present wiring harness”) will now be provided.

1. Present Anticorrosive

The present anticorrosive mainly contains an insulating resin. It is preferable that the insulating resin has a volume resistivity value of 10¹⁰ Ω·cm or more. Examples of the insulating resin include various types of curable resins that are cured with light (preferably ultraviolet light), heat and moisture, and thermoplastic resins.

Examples of the curable resins include a thermal curable epoxy resin, an ultraviolet curable (meth) acrylic resin (specific examples of the resin yet to be cured include a (meth)acrylate monomer and a (meth)acrylate oligomer). Meanwhile, examples of the thermoplastic resins include a vinyl chloride resin, an ethylene-vinyl acetate copolymer, and a polyamide resin.

The present anticorrosive may consist of a single kind of insulating resin alone, or consist of a mixture or compound of two or more than two kinds of insulating resins. The present anticorrosive may further contain an additive, another monomer, another oligomer and/or a polymer within a range of not impairing its physical properties.

The additive described above is not limited specifically if an additive that can be generally used for a material for resin molding is used. To be specific, examples of the additive include a curing agent, a filler, an antioxidant, a metal deactivator (a copper inhibitor), an ultraviolet absorber, an ultraviolet-concealing agent, a flame-retardant auxiliary agent, a processing aid (e.g., a lubricant, wax), carbon and other coloring pigments, a flexibilizer, an agent providing shock resistance, an organic filler, a dilution agent (e.g., a solvent), a thixotropic agent, coupling agents of various kinds, a defoamer, and a levelling agent.

Among the additives described above, the coloring pigments and the fillers are preferably used because if the total light transmittance only of the insulating resin falls outside a range of the total light transmittance defined in the present invention, the addition of the coloring pigments and the fillers allows the total light transmittance to be adjusted easily so as to fall within the defined range.

When using the curable resin as the insulating resin, the present anticorrosive is cured after being applied to a site such as a connected portion of a wire in order to increase mechanical strength of the site. Examples of a curing method include curing with ultraviolet irradiation, curing with electron irradiation, thermal curing and moisture curing. The curing method can be chosen depending on the kind of the insulating resin. The curing may be performed in the air or under an inert gas atmosphere of nitrogen or argon.

In a case where the curable resin is chosen and the present anticorrosive is applied to the connected portion of the wire, if there exists a site where light such as ultraviolet light cannot easily reach or cannot reach such as space between elemental wires of a wire conductor and such as an area where a shadow of a terminal member lies, another curing method such as thermal curing and moisture curing can be used in addition to the light irradiation curing.

The present anticorrosive has a total light transmittance of less than 85%, which is measured in accordance with the JIS K7361-1. That is, when the present anticorrosive consists of a single kind of insulating resin alone that is selected from the insulating resins described above, the total light transmittance of the insulating resin is accordingly within the range described above. When the present anticorrosive consists of two or more than two kinds of insulating resins selected from the insulating resins described above, the total light transmittance of a mixture or a compound of the insulating resins is accordingly within the range described above. When the present anticorrosive contains the other monomer, the other polymer and/or the other elements described above in addition to the insulating resin, the total light transmittance of a mixture or a compound of the insulating resin, the other monomer, the other polymer and/or the other elements is accordingly within this range. It is to be noted that when the curable resin is used as the insulating resin, the total light transmittance described above indicates a value after curing.

If the total light transmittance is 85% or more, the anticorrosive cannot obtain sufficient anticorrosive capability when exposed to artificial light such as fluorescent light and incandescent light or sunlight after applied. The details of the factors are unclear; however, it is assumed that easy transmission of the light such as ultraviolet light through the anticorrosive causes a tiny crack in a contact interface between the anticorrosive and the connected portion of the wire, which prevents the anticorrosive from obtaining sufficient anticorrosive capability while the anticorrosive applied to the connected portion of the wire is in intimate contact with the portion without being peeled off. The total light transmittance is preferably 80% or less, and more preferably 75% or less considering that the present anticorrosive can demonstrate sufficient anticorrosive capability more easily even after exposed to the light. The present anticorrosive may be colored or uncolored, and its color is not limited specifically.

For example, the present anticorrosive can be favorably used to prevent corrosion from building up at an electrically connected portion between a wire conductor and a terminal member of a coated electric wire that is used for wiring in a car such as an automobile.

2. Present Coated Electric Wire

Next, a description of the present coated electric wire is provided.

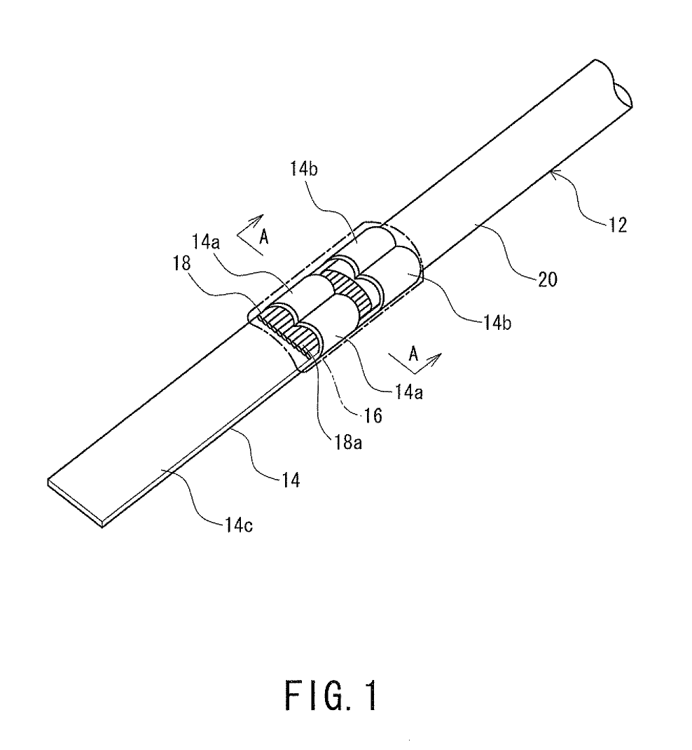

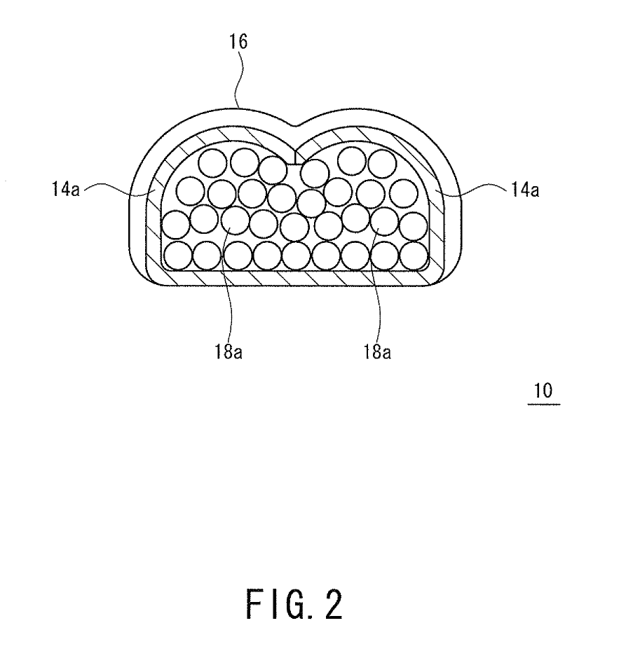

A present coated electric wire 10 includes a coated electric wire 12 including a wire conductor 18 and an insulation 20 with which the wire conductor 18 is coated, and a terminal member 14 connected to an end of the wire conductor 18 of the coated electric wire 12, as shown in FIGS. 1 and 2.

The insulation 20 is peeled off at the end of the wire conductor 18 of the coated electric wire 12, so that the wire conductor 18 is exposed at the end. The terminal member 14 is connected to the exposed end of the wire conductor 18. The wire conductor 18 defines a strand made up of a plurality of elemental wires 18a. In this case, the strand may be made up of metallic elemental wires of one kind, or may be made up of metallic elemental wires of more than one kind. The strand may include an elemental wire made of an organic fiber in addition to the metallic elemental wires. It is to be noted that the strand made up of the metallic elemental wires of one kind defines a strand made up of metallic elemental wires that are all made of a same metallic material, and the strand made up of the metallic elemental wires of more than one kind defines a strand made up of metallic elemental wires that are made of metallic materials different from each other. The strand may include also a reinforcement wire (tension member) for reinforcing the coated electric wire.

The metallic elemental wires are made preferably of copper, a copper alloy, aluminum, an aluminum alloy, or materials that are produced by furnishing these materials with plating of various kinds. An elemental wire that is defined as the reinforcement wire is made preferably of a copper alloy, titanium, tungsten or stainless steel. An elemental wire made of the organic fiber that is defined as the reinforcement wire is made preferably of KEVLAR.

The insulation 20 is made preferably from rubber, polyolefin, PVC or a thermoplastic elastomer, which may be used singly or in combination. The insulation 20 may contain a variety of additives such as a flame retardant, a filler and a coloring agent as appropriate.

The terminal member 14 includes a connecting portion 14c having the shape of a tab and arranged to be connected to a counterpart terminal, wire barrels 14a extending from a base end of the connecting portion 14c and crimped onto the end of the wire conductor 18 of the electric wire 12, and insulation barrels 14b extending from the wire barrels 14a and crimped onto the insulation 20 at the end of the coated electric wire 12.

The terminal member 14 (a base member thereof) is made preferably of general brass, a variety of copper alloys or copper. It is preferable to plate a partial surface (e.g., a connecting point) or an entire surface of the terminal member 14 with a metal such as tin, nickel and gold.

A portion of the wire conductor 18 is exposed at an electrically connected portion between the wire conductor 18 and the terminal member 14 at the wire end. In the present coated electric wire 10, the exposed portion is coated with the anticorrosive described above. To be specific, a coating film 16 of the anticorrosive lies over from the base end of the connecting portion 14c while striding over the border between the base end of the connecting portion 14c of the terminal member 14 and the end of the wire conductor 18 until the insulation 20 while striding over the border between the insulation barrels 14b of the terminal member 14 and the insulation 20.

The anticorrosive to be used has the physical properties within the range described above, considering the combination of the material of the wire conductor 18 and the material of the terminal member 14. The thickness of the coating film 16 of the anticorrosive is adjusted as appropriate; however, the thickness is preferably from 0.01 mm to 0.1 mm. If the thickness of the coating film 16 is too large, it is difficult for the terminal member 14 to be inserted into a connector. On the other hand, if the thickness of the coating film 16 is too small, the anticorrosion effect is liable to be lessened.

After crimping the terminal member 14 onto the wire end to connect the wire conductor 18 and the terminal member 14, the anticorrosive is applied to a surface of the connected portion between the wire conductor 18 and the terminal member 14, that is, a surface at the end of the insulation 20, surfaces of the insulation barrels 14b, surfaces of the wire barrels 14a, a surface of the exposed wire conductor 18, and a surface of the base end of the connecting portion 14c. Thus, the coating film 16 is formed on the surface of the connected portion between the wire conductor 18 and the terminal member 14.

It is also preferable to form a coating film 16 of the anticorrosive on a back surface of the tab-shaped connecting portion 14c extending from the wire barrels 14a of the terminal member 14, back surfaces of the wire barrels 14a, and back surfaces of the insulation barrels 14b if the formed coating film 16 does not impair the electrical connection.

In applying the anticorrosive, a falling-drop method or a coating method is preferably used. The anticorrosive may be heated or cooled as necessary.

If a curable resin yet to be cured is used as the insulating resin, after the anticorrosive is applied to the connected portion of the wire, the coating film 16 of the anticorrosive can be cured with light irradiation such as ultraviolet irradiation, heat, or moisture in order to increase mechanical strength.

Being solidified after the curing, the anticorrosive is not sticky at the time of handling, and can be fixed to the applied site over a long period of time. Thus, the anticorrosion effect can be sustained over a long period of time. In addition, the anticorrosive is capable of demonstrating high anticorrosive capability even after exposed to ultraviolet light.

3. Present Wiring Harness

A plurality of coated electric wires with terminals including the present coated electric wires 10 are bunched into the present wiring harness. In the present wiring harness, some of the included coated electric wires may be the present coated electric wires 10, or all of the included coated electric wires may be the present coated electric wires 10.

In the present wiring harness, the coated electric wires may be bound with tape, or may be armored with an armoring member such as a circular tube, a corrugated tube and a protector.

The present wiring harness is favorably used for wiring in a car such as an automobile, especially for wiring in an engine room or the interior of a car that is subject to water. These sites are susceptible to heat and water, so that when a wiring harness is used for wiring in these sites, rust is liable to form at an electrically connected portion between a wire conductor 18 and a terminal member 14. However, using the present wiring harness can effectively prevent rust from forming at the electrically connected portion between the wire conductor 18 and the terminal member 14.

### EXAMPLE

A description of the present invention will now be specifically provided with reference to Examples. It is to be noted that the present invention is not limited to Examples.

1. Preparation of Coated Electric Wire

A polyvinyl chloride composition was prepared as follows: 100 parts by mass of polyvinyl chloride (polymerization degree of 1300) was mixed with 40 parts by mass of diisononyl phthalate that defines a plasticizer, 20 parts by mass of calcium carbonate heavy that defines a filler, and 5 parts by mass of a calcium-zinc stabilizer that defines a stabilizer at 180 degrees C. in an open roll, and the mixture was formed into pellets with the use of pelletizer.

Then, a conductor (having a cross-sectional area of 0.75 mm) that defines an aluminum alloy strand that is made up of seven aluminum alloy wires was extrusion-coated with the polyvinyl chloride composition prepared as above such that the coat has a thickness of 0.28 mm. In this manner, coated electric wires (PVC electric wires) were prepared.

2. Preparation of Coated Electric Wire with Terminal

Coated electric wires with terminals were prepared as follows. The coat was peeled off at an end of each coated electric wire prepared as above to expose the wire conductor, and then a male crimping terminal member (0.64 mm in width at a tab) that is made of brass and generally used for automobile was crimped onto the end of each coated electric wire.

Then, anticorrosives of different kinds shown in Table 1 were applied to electrically connected portions between the wire conductors and the terminal members, and thus the exposed wire conductors and barrels of the terminal members were coated with the anticorrosives. In this manner, the coated electric wires with the terminals were prepared. The anticorrosives were applied such that the coats have a thickness of 0.05 mm.

Concerning the anticorrosives that contained thermoplastic resins, the thermoplastic resins were heated to a predetermined temperature to be liquefied, and then applied to the electrically connected portions. Concerning the anticorrosives that contained thermal curable resins, the thermal curable resins were applied to the electrically connected portions, and then individually cured in a constant-temperature oven. Concerning the anticorrosives that contained ultraviolet curable resins, the ultraviolet curable resins were applied to the electrically connected portions, and then the electrically connected portions were individually placed on a light-collecting area (focal area) of a UV light irradiation device of 800 watts including a metal halide lamp and a collection cold mirror (manuf.: ORC MANUFACTURING CO., LTD.) to be cured with ultraviolet irradiation by being irradiated with ultraviolet light of 5000 mJ/cm² or more.

The total light transmittances of the anticorrosives shown in Table 1 were measured in accordance with the JIS K7361-1.

3. Evaluation Procedure

Evaluations of peeling and anticorrosive capability of the anticorrosives of different kinds were performed on the coated electric wires with the terminals that were coated with the anticorrosives.

(Peel Test <Early stage>)

After being applied (after being cured if curing was necessary), the anticorrosives of different kinds were individually scratched with nails. The coated electric wires with the terminals whose anticorrosives did not peel off were evaluated as PASSED. The coated electric wires with the terminals whose anticorrosives peeled off were evaluated as FAILED. It is to be noted that the anticorrosives that peeled off obviously have inferior anticorrosive capability.

(Peel Test <Later Stage After Exposure to Ultraviolet Light>)

After being applied (after being cured if curing was necessary), each of the anticorrosives was exposed to 100 cycles of ultraviolet light (1 cycle: 12-hour irradiation consisting of 8-hour irradiation and 4-hour irradiation), which is A method specified in the JIS K7350-3: Cycle No. 1 of artificial weathering. Then, the anticorrosives of different kinds were individually scratched with nails. The coated electric wires with the terminals whose anticorrosives did not peel off were evaluated as PASSED. The coated electric wires with the terminals whose anticorrosives peeled off were evaluated as FAILED. It is to be noted that the anticorrosives that peeled off obviously have inferior anticorrosive capability.

(Anticorrosive Capability <Early stage>)

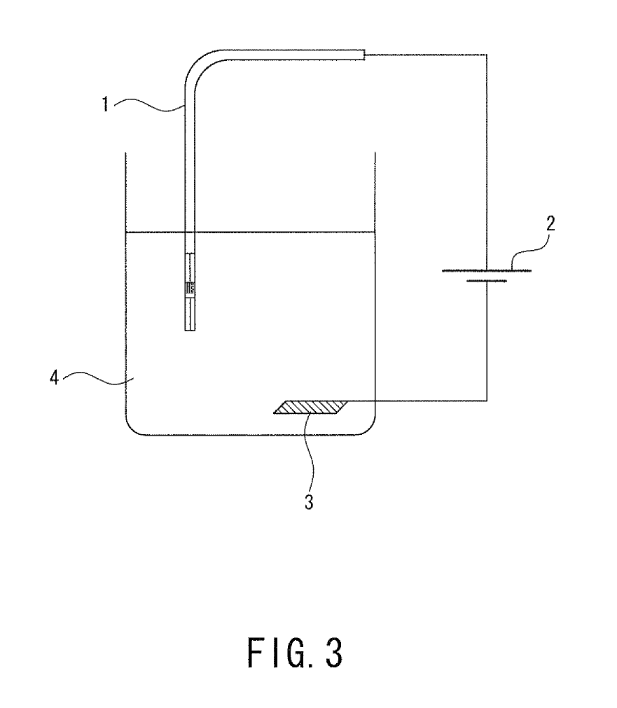

As shown in FIG. 3, each of the prepared coated electric wires 1 with the terminals was connected to a positive electrode of an electrical power source 2 of 12 volts, while a pure copper plate 3 (1 cm in width×2 cm in length×1 mm in thickness) was connected to a negative electrode of the electrical power source 2 of 12 volts. The pure copper plate 3 and the electrically connected portion between the wire conductor of each coated electric wire 1 and the terminal member were immersed in 300 cc of a water solution 4 containing 5% of NaCl, and a voltage of 12 volts was applied thereto for two minutes. After the application of the voltage, ICP emission analysis of the water solution 4 was performed to measure the amount of aluminum ions eluted from the wire conductor of each coated electric wire 1 with the terminal. The coated electric wires 1 with the terminals in which the amounts of aluminum ions eluted from the wire conductors were less than 0.1 ppm were evaluated as PASSED. The coated electric wires 1 with the terminals in which the amounts of aluminum ions eluted from the wire conductors were 0.1 ppm or more were evaluated as FAILED.

(Anticorrosive Capability <Later Stage After Exposure to Ultraviolet Light>)

After being applied (after being cured if curing was necessary), each of the anticorrosives was exposed to 100 cycles of ultraviolet light (1 cycle: 12-hour irradiation consisting of 8-hour irradiation and 4-hour irradiation), which is A method specified in the JIS K7350-3: Cycle No. 1 of artificial weathering. Then, as shown in FIG. 3, each of the prepared coated electric wires 1 with the terminals was connected to a positive electrode of an electrical power source 2 of 12 volts, while a pure copper plate 3 (1 cm in width×2 cm in length×1 mm in thickness) was connected to a negative electrode of the electrical power source 2 of 12 volts. The pure copper plate 3 and the electrically connected portion between the wire conductor of each coated electric wire 1 and the terminal member were immersed in 300 cc of a water solution 4 containing 5% of NaCl., and a voltage of 12 volts was applied thereto for two minutes. After the application of the voltage, ICP emission analysis of the water solution 4 was performed to measure the amount of aluminum ions eluted from the wire conductor of each coated electric wire 1 with the terminal. The coated electric wires 1 with the terminals in which the amounts of aluminum ions eluted from the wire conductors were less than 0.1 ppm were evaluated as PASSED. The coated electric wires 1 with the terminals in which the amounts of aluminum ions eluted from the wire conductors were 0.1 ppm or more were evaluated as FAILED.

Table 1 below presents the kinds, total light transmittances, and results of the evaluation of the anticorrosive of present Examples and Comparative Examples.

TABLE 1

| | | | | | | | Comparative | Comparative | Comparative | Comparative |
|---|---|---|---|---|---|---|---|---|---|---|
| | | Example 1 | Example 2 | Example 3 | Example 4 | Example 5 | Example 1 | Example 2 | Example 3 | Example 4 |
| Insulating resin | | PVC | Ethylene- | Polyamide | Thermal | UV curable | PMMA | Poly- | PVC | UV curable |
| | | | vinyl | resin | curable | (meth)acrylic | | carbonate | | (meth)acrylic |
| | | | acetate | | epoxy resin | resin | | | | resin |
| | | | copolymer | | | | | | | |
| Total light transmit- | | 70 | 65 | 80 | 30 | 60 | 90 | 86 | 85 | 90 |
| tance (%) | | | | | | | | | | |
| Peeling | Early stage | PASSED | PASSED | PASSED | PASSED | PASSED | PASSED | PASSED | PASSED | PASSED |
| | Later stage | PASSED | PASSED | PASSED | PASSED | PASSED | PASSED | PASSED | PASSED | PASSED |
| Anti- | Early stage | PASSED | PASSED | PASSED | PASSED | PASSED | PASSED | PASSED | PASSED | PASSED |
| corrosive | Later stage | PASSED | PASSED | PASSED | PASSED | PASSED | FAILED | FAILED | FAILED | FAILED |
| capability | | | | | | | | | | |

As is evident from Table 1, the anticorrosives of Comparative Examples had total light transmittances that fell outside the range specified by the present invention. Thus, while good in anticorrosive capability at the early stage, the anticorrosives of Comparative Examples were inferior in anticorrosive capability at the later stage after the exposure to the ultraviolet light. The details of the factors are unclear; however, it is assumed that while the anticorrosives of Comparative Examples applied to the connected portions of the wires were in intimate contact with the connected portions of the wires without being peeled off, the excessive transmission of the ultraviolet light through the anticorrosives of Comparative Examples caused tiny cracks in contact interfaces between the anticorrosives and the connected portions of the wires, which prevented the anticorrosives from obtaining sufficient anticorrosive capability.

Meanwhile, the anticorrosives of the present invention had total light transmittances that fell within the range specified by the present invention. Thus, the anticorrosives of the present invention were sufficiently in intimate contact with the electrically connected portions, and were capable of demonstrating excellent anticorrosive capability both at the early stage and at the later stage after the exposure to the ultraviolet light. It is assumed that because the total light transmittances of the anticorrosives of the present invention fell within the range specified by the present invention, the ultraviolet light could not easily reach contact interfaces between the anticorrosives and the connected portions of the wires, which did not cause tiny cracks in the contact interfaces.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

For example, though the coated electric wire 10 has the configuration of including the male terminal including the tab-shaped connecting portion 14c, which defines the terminal member 14, the present invention is not limited to this configuration. It is also preferable that a female terminal capable of fitting into a male terminal, or a tuning-fork terminal is used as the terminal member 14. In addition, it is also preferable that the terminal member 14 does not include the insulation barrels 14b, and the crimp is performed only by the wire barrels 14a. In addition, the method for connecting the wire conductor 12 and the terminal member 14 is not limited to the crimp using the barrels, and it is also preferable that the wire conductor 12 and the terminal member 14 are connected by a method such as pressure-resistance welding, ultrasonic welding and soldering. In addition, though the conductor 18 defines a strand in the preferred embodiments, it is preferable that the conductor 18 defines a single wire.

1. An anticorrosive that mainly contains an insulating resin, and has a total light transmittance of less than 85%, which is measured in accordance with the JIS K7361-1.

2. The anticorrosive according to claim 1 that comprises an anticorrosive applied to an electrically connected portion between a wire conductor and a terminal member.

3. A coated electric wire with a terminal, the electric wire comprising a wire conductor and a terminal member, wherein an electrically connected portion between the wire conductor and the terminal member is coated with the anticorrosive according to claim 2.

4. The coated electric wire with the terminal according to claim 3, wherein the wire conductor comprises elemental wires made of aluminum or an aluminum alloy, and the terminal member is made of copper or a copper alloy.

5. A wiring harness comprising the coated electric wire with the terminal according to claim 4.

6. A wiring harness comprising the coated electric wire with the terminal according to claim 3.

7. A coated electric wire with a terminal, the electric wire comprising a wire conductor and a terminal member, wherein an electrically connected portion between the wire conductor and the terminal member is coated with the anticorrosive according to claim 1.

8. A wiring harness comprising the coated electric wire with the terminal according to claim 7.
